(19) United States
(12) Patent Application Publication
(10) Pub. No.: US 2013/0233761 A1
(43) Pub. Date: Sep. 12, 2013

(54) Buffer Sheet Facilitating Chuck Adsorption and Taking and Glass Transport Package

(71) Applicants: Shihhsiang Chen, Shenzhen (CN); Qinjun Shi, Shenzhen (CN)

(72) Inventors: Shihhsiang Chen, Shenzhen (CN); Qinjun Shi, Shenzhen (CN)

(21) Appl. No.: 13/512,694

(22) PCT Filed: Apr. 28, 2012
(86) PCT No.: PCT/CN12/74915

§ 371 Date: May 30, 2012

(30) Foreign Application Priority Data
Mar. 6, 2012 (CN) 201210056978.0

(51) Int. Cl. B32B 3/10; B32B 3/26; B65D 81/127; B32B 33/00

(52) U.S. Cl. 206/593; 428/141; 428/131

(57) ABSTRACT

The invention relates to the field of package, and more particularly to a buffer sheet facilitating chuck adsorption and taking and a glass transport package. The buffer sheet comprises a substrate, and surface grains protruding from the substrate; the buffer sheet comprises adsorption zones, and non-adsorption zones; the surface grains of the adsorption zones are of a close pore structure, and the surface grains of the non-adsorption zones are partially or fully of an open pore structure for avoiding generating negative pressure. The liquid crystal glass transport package of the invention employs a buffer sheet of an innovative structure. Because the surface of the adsorption zones of the buffer sheet is still of a closed surface grain structure, the chuck adsorption capacity is not affected. The surface grains of the non-adsorption zones are fully or partially opened. The open pore structure enables the outside air and the air between the buffer sheet and the glass plates to freely flow. Thus, the problem of vacuum adsorption between the buffer sheet and the glass plates is solved, sheets are easily and successfully taken out, the phenomenon that the sheets are stuck and broken is better eliminated, and the time for taking sheets is greatly saved.

### TECHNICAL FIELD

The invention relates to the field of package, and more particularly to a buffer sheet facilitating chuck adsorbing and taking, and a glass transport package.

### BACKGROUND

Conventional liquid crystal display (LCD) devices in mass production employ some large-size thin glass plate. To prevent the glass plates from being broken during transportation, multilayer glass plates are superposed in a packaging container to form a glass transport package. As shown in FIG. 1 and FIG. 2, a buffer sheet 2 which prevents the glass plates from mutually sticking and plays a buffer role is arranged between two adjacent glass plates 1, and the buffer sheet 2 is provided with closed diamond grid-shaped surface grains. After interactively superposing and packaging the glass plates 1 and the buffer sheets 2, and standing the packaging container for a while, the buffer sheets 2 and the glass plates 1 are adsorbed by vacuum and are difficult to separate, causing the glass plates and the buffer sheets are difficult to take out and separate, and even causing the glass to break.

### SUMMARY

In view of the above-described problems, the aim of the invention is to provide a liquid crystal glass transport package and a buffer sheet facilitating chuck adsorption and taking

A first technical scheme of the invention is that: a buffer sheet facilitating chuck adsorption and taking comprises a substrate, and surface grains protruding from the substrate; the buffer sheet comprises adsorption zones, and non-adsorption zones; the surface grains of the adsorption zones are of a close pore structure, and the surface grains of the non-adsorption zones are partially or fully of an open pore structure for avoiding generating negative pressure.

Preferably, the open pore structure of the surface grains of the non-adsorption zone is provided with open paths only facing the two parallel edges of the buffer sheet. Air is supplemented from two directions, and better effect is obtained because the air complementing paths are direct and short.

Preferably, the open pore structure of the surface grains of the non-adsorption zones is provided with open paths facing all the four edges of the buffer sheet. Air is supplemented to the non-adsorption zones from four directions, and then the problem of vacuum adsorption can be effectively solved.

Preferably, the heights of the surface grains of the non-adsorption zones are consonant.

Preferably, the heights of the surface grains of the non-adsorption zones are inconsistent. The stepped buffer structure has better buffer effect, and different heights of the surface grains further widen the air inlet/outlet passage, thereby more effectively preventing vacuum adsorption.

Preferably, the surface of the substrate is airtight.

A second technical scheme of the invention is that: a buffer sheet facilitating chuck adsorption and taking comprises a substrate; wherein the buffer sheet comprises adsorption zones, and non-adsorption zones; the non-adsorption zones are provided with through hole(s) used for avoiding generating negative pressure.

Preferably, the number of the through hole(s) is two or more.

Preferably, the substrate of the adsorption zones is further provided with surface grains protruding from the substrate, and the surface grains of the adsorption zones are of a closed pore structure.

Preferably, the substrate of the non-adsorption zones is further provided with surface grains protruding from the substrate, and the surface grains of the non-adsorption zones are fully or partially of an open pore structure.

Preferably, the heights of the surface grains of the non-adsorption zones are consonant.

Preferably, the heights of the surface grains of the non-adsorption zones are inconsistent. The stepped buffer structure has better buffer effect, and different heights of the surface grains further widen the air inlet/outlet passage, thereby more effectively preventing vacuum adsorption.

The invention further provides a liquid crystal glass transport package, comprising glass plates, and a buffer sheet; the buffer sheet is arranged between two adjacent glass plates. The buffer sheet comprises a substrate, and surface grains protruding from the substrate; the buffer sheet comprises adsorption zones, and non-adsorption zones; the surface grains of the adsorption zones are of a close pore structure, and the surface grains of the non-adsorption zones are partially or fully of an open pore structure for avoiding generating negative pressure.

Preferably, the open pore structure of the surface grains of the non-adsorption zones is provided with open paths only facing the two parallel edges of the buffer sheet.

Preferably, the open pore structure of the surface grains of the non-adsorption zones is provided with open paths facing all the four edges of the buffer sheet.

Preferably, the heights of the surface grains of the non-adsorption zones are consonant.

Preferably, the heights of the surface grains of the non-adsorption zones are inconsistent.

Preferably, the surface of the substrate is airtight.

The open pore structure of the invention is an open surface grain structure formed by fully or partially opening the surface grains of the substrate, called open pore structure for short here. The open pore structure enables the outside air and the air between the buffer sheet and the glass plates to freely flow, namely, the outside air can quickly enter between the buffer sheet and the glass plates from the periphery of the buffer sheet. Because the close pore structure is in a closed state of the surface grains of the substrate, the air between the buffer sheet and the glass plates can not be circulated with the outside air.

Advantages of the invention are summarized below: the liquid crystal glass transport package of the invention employs a buffer sheet of an innovative structure, and the buffer sheet is divided into adsorption zones, and non-adsorption zones. The surface grains of the adsorption zones are of a close pore structure, and the surface grains of the non-adsorption zones are partially or fully of an open pore structure. Because the surface of the adsorption zones of the buffer sheet is still of a closed surface grain structure, the chuck adsorption capacity is not affected. The surface grains of the non-adsorption zones of the buffer sheet are fully or partially opened, to form an open surface grain structure. The open pore structure enables the outside air and the air between the buffer sheet and the glass plates to freely flow, namely the outside air can quickly enter between the buffer sheet and the glass plates from the periphery of the buffer sheet. Thus, the problem of vacuum adsorption between the buffer sheet and the glass plates is solved, sheets are easily and successfully taken out, the phenomenon that the sheets are stuck and broken is better eliminated, and the time for taking sheets is greatly saved.

The buffer sheet of the invention is divided into adsorption zones and non-adsorption zones, and the non-adsorption zones are provided with through hole(s); thus, the problem of vacuum adsorption between the buffer sheet and the glass plates can also be solved. The outside air can quickly enter between the buffer sheet and the glass plates from the edges of the through hole(s), thereby preventing the problem of vacuum adsorption.

### BRIEF DESCRIPTION OF FIGURES

FIG. 1 is a schematic diagram of glass plates arranged in a packaging container in the prior art;

FIG. 2 is a structure diagram of a buffer sheet in the prior art;

FIG. 3 is a structure diagram of a buffer sheet of a first example of the invention;

FIG. 4 is a structure diagram of a buffer sheet of a second example of the invention;

FIG. 5 is a sectional diagram of a non-adsorption zone of a buffer sheet shown in FIG. 4;

FIG. 6 is a sectional diagram of a non-adsorption zone of a third example of a buffer sheet of the invention;

FIG. 7 is a structure diagram of a fourth example of a buffer sheet of the invention; and

FIG. 8 is a structure diagram of a fifth example of a buffer sheet of the invention.

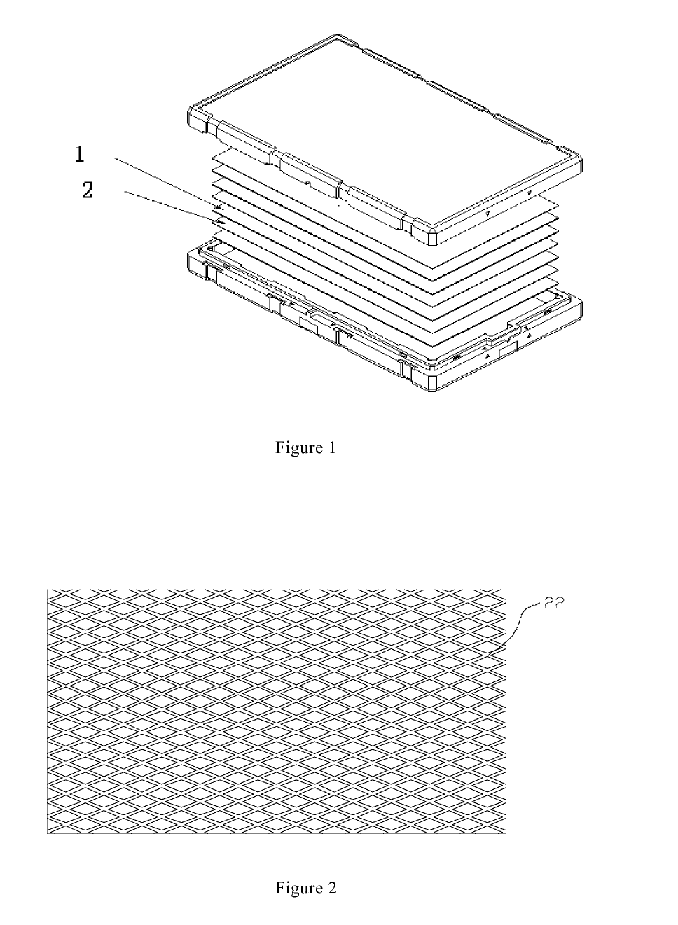

Legends: 1. glass plate; 2. buffer sheet; 21. substrate; 22. surface grain; 23. adsorption zone; 24. non-adsorption zone; 25. through hole.

### DETAILED DESCRIPTION

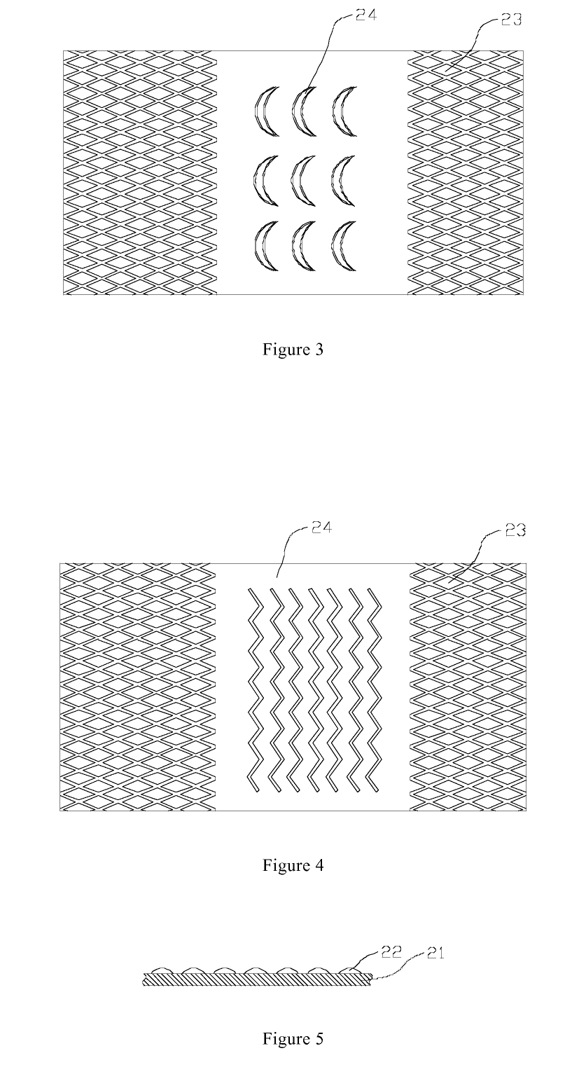

The invention provides a liquid crystal glass transport package, comprising glass plates, and a buffer sheet; the buffer sheet is arranged between two adjacent glass plates. The liquid crystal glass transport package of the invention employs a buffer sheet of an innovative structure. FIG. 3 shows a first example of the buffer sheet of the invention. The buffer sheet comprises a substrate, and surface grains protruding from the substrate; the buffer sheet comprises adsorption zones 23, and non-adsorption zones 24; the surface grains of the adsorption zones 23 are of a close pore structure, and the surface grains of the non-adsorption zones 24 are partially of an open pore structure for avoiding generating negative pressure. The surface of the substrate is airtight. In the example, the non-adsorption zones 24 are positioned in the middle of the buffer sheet, and the adsorption zones 23 are positioned at both ends of the buffer sheet. The surface grains of the adsorption zones 23 are in a shape of diamond grids, and the surface grains of the non-adsorption zones 24 are in a shape of crescent grids which are separately arranged. The crescent grids are closed, but the zones among the crescent grids are opened. The open pore structure of the surface grains of the non-adsorption zone 24 is provided with open paths facing all the four edges of the buffer sheet. Air is supplemented to the surface grains of the non-adsorption zones 24 from four directions, and then the problem of vacuum adsorption is effectively solved.

The buffer sheet is divided into adsorption zones 23 and non-adsorption zones 24; the surface grains of the adsorption zones 23 are of a close pore structure, and the surface grains of the non-adsorption zones 24 are partially of an open pore structure. Because the surface of the adsorption zones 23 of the buffer sheet is still of a closed surface grain structure, the chuck adsorption capacity is not affected. The surface grains of the non-adsorption zones 24 of the buffer sheet are fully or partially opened, to form an open surface grain structure. The open pore structure enables the outside air and the air between the buffer sheet and the glass plates to freely flow, namely, the outside air can quickly enter between the buffer sheet and the glass plates from the periphery of the buffer sheet. Thus, the problem of vacuum adsorption between the buffer sheet and the glass plates is solved, sheets are easily and successfully taken out, the phenomenon that the sheets are stuck and broken is better eliminated, and the time for taking sheets is greatly saved.

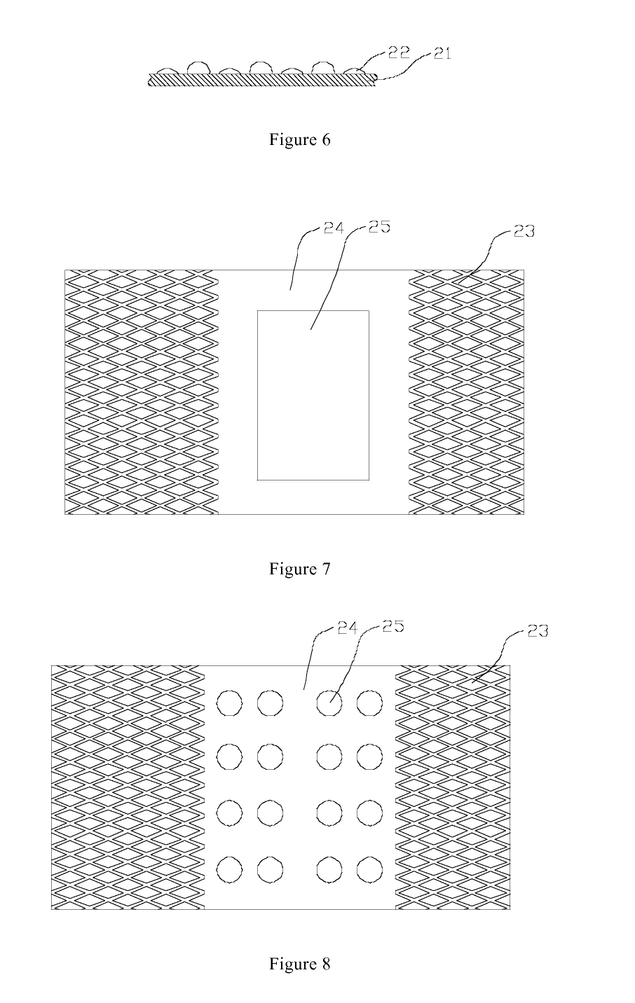

FIG. 4 and FIG. 5 show a second example of the buffer sheet. The buffer sheet comprises a substrate 21, and surface grains 22 protruding from the substrate 21; the surface grains 22 of the non-adsorption zones 24 are in a shape of strip-shaped broken lines, and the surface grains do not form the shape of grids. Thus, all the non-adsorption zones are of an open structure, and air freely enters the non-adsorption zones. The heights of the surface grains 22 of the non-adsorption zones 24 are consonant. Optionally, the heights of the surface grains 22 of the non-adsorption zones 24 can be inconsistent. The stepped buffer structure has better buffer effect. Specifically, FIG. 6 shows a third example, and different heights of the surface grains can further widen the air inlet/outlet passage, thereby more effectively preventing vacuum adsorption. In the example, the open pore structure of the surface grains of the non-adsorption zones 24 is provided with open paths only facing the two parallel edges of the buffer sheet. Air is supplemented from two directions, and better effect is able to be obtained because the air complementing paths are direct and short.

FIG. 7 shows a fourth example of the buffer sheet of the invention. The buffer sheet comprises a substrate; the buffer sheet comprises adsorption zones 23, and non-adsorption zones 24; the non-adsorption zones 24 are provided with a through hole 25. In the example, the non-adsorption zones 24 are positioned in the middle of the buffer sheet, and the adsorption zones 23 are positioned at both ends of the buffer sheet. The number of the through hole 25 is one, the area thereof is large, and the shape thereof is rectangle.

The buffer sheet of the invention is divided into adsorption zones 23 and non-adsorption zones 24, and the non-adsorption zones 24 are provided with through hole(s) 25; thus, the problem of vacuum adsorption between the buffer sheet and the glass plates can be solved as well. The outside air can quickly enter between the buffer sheet and the glass plates from the edges of the through hole(s) 25, thereby preventing the problem of vacuum adsorption.

In the example, the substrate of the adsorption zones is further provided with surface grains protruding from the substrate; the surface grains of the adsorption zones 23 are of a close pore structure, to facilitate chuck adsorption.

In the example, the non-adsorption zones are provided surface grains or are not provided with surface grains. When the non-adsorption zones are provided surface grains, the surface grains of the non-adsorption zones are partially or fully of an open pore structure. The heights of the surface grains of the non-adsorption zones can be consonant or inconsistent. The function of the open pore structure of the surface grains in the example is the same as that of the open pore structure in the above example, and the example will not give unnecessary details.

FIG. 8 shows a fifth example of the buffer sheet of the invention, and the fifth example is different from the seventh example in that: the number of the through holes 25 is multiple. The through holes 25 are in multiple rows and lines, and are in round shape. Optionally, the through holes 25 can be in other shapes. The functions of the through holes 25 are the same as those in the seventh example, and the example will not give unnecessary details.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A buffer sheet facilitating chuck adsorption and taking, comprising: a substrate, and surface grains protruding from said substrate; wherein said buffer sheet comprises adsorption zones, and non-adsorption zones; the surface grains of said adsorption zones are of a close pore structure, and the surface grains of said non-adsorption zones are partially or fully of an open pore structure for avoiding generating negative pressure.

2. The buffer sheet facilitating chuck adsorption and taking of claim 1, wherein the open pore structure of the surface grains of said non-adsorption zones is provided with open paths only facing the two parallel edges of said buffer sheet.

3. The buffer sheet facilitating chuck adsorption and taking of claim 1, wherein the open pore structure of the surface grains of said non-adsorption zones is provided with open paths facing all the four edges of said buffer sheet.

4. The buffer sheet facilitating chuck adsorption and taking of claim 1, wherein the heights of the surface grains of said non-adsorption zones are consonant.

5. The buffer sheet facilitating chuck adsorption and taking of claim 1, wherein the heights of the surface grains of said non-adsorption zones are inconsistent.

6. The buffer sheet facilitating chuck adsorption and taking of claim 1, wherein the surface of said substrate is airtight.

7. A buffer sheet facilitating chuck adsorption and taking, comprising: a substrate; wherein said buffer sheet comprises adsorption zones, and non-adsorption zones; the non-adsorption zones are provided with through hole(s) for avoiding generating negative pressure.

8. The buffer sheet facilitating chuck adsorption and taking of claim 7, wherein the number of said through holes are two or more.

9. The buffer sheet facilitating chuck adsorption and taking of claim 7, wherein the substrate of said adsorption zones is further provided with surface grains protruding from said substrate, and the surface grains of said adsorption zones are of a close pore structure.

10. The buffer sheet facilitating chuck adsorption and taking of claim 7, wherein the substrate of said non-adsorption zones is further provided with surface grains protruding from said substrate, and the surface grains of said non-adsorption zones are fully or partially of an open pore structure.

11. The buffer sheet facilitating chuck adsorption and taking of claim 10, wherein the heights of the surface grains of said non-adsorption zones are consonant.

12. The buffer sheet facilitating chuck adsorption and taking of claim 10, wherein the heights of the surface grains of said non-adsorption zones are inconsistent.

13. An liquid crystal glass transport package , comprising: glass plates, and a buffer sheet(s); wherein said buffer sheet is arranged between two adjacent glass plates; said buffer sheet comprises a substrate, and surface grains protruding from said substrate; said buffer sheet comprises adsorption zones, and non-adsorption zones; the surface grains of said adsorption zones are of a close pore structure, and the surface grains of said non-adsorption zones are partially or fully of an open pore structure for avoiding generating negative pressure.

14. The liquid crystal glass transport package of claim 13, wherein the open pore structure of the surface grains of said non-adsorption zones is provided with open paths only facing the two parallel edges of said buffer sheet.

15. The liquid crystal glass transport package of claim 13, wherein the open pore structure of the surface grains of said non-adsorption zones is provided with open paths facing all the four edges of said buffer sheet.

16. The liquid crystal glass transport package of claim 13, wherein the heights of the surface grains of said non-adsorption zones are consonant.

17. The liquid crystal glass transport package of claim 13, wherein the heights of the surface grains of said non-adsorption zones are inconsistent.

18. The liquid crystal glass transport package of claim 13, wherein the surface of said substrate is airtight.
